(19) United States
(12) Patent Application Publication
(10) Pub. No.: US 2026/0326646 A1
(43) Pub. Date: Oct. 22, 2026

(54) STEERING WHEEL DESK

(71) Applicant: Shenzhen Yuanzhi Auto Accessories Co., Ltd., Shenzhen (CN)

(72) Inventors: Yue Yang, Shenzhen (CN); Xing Ye, Shenzhen (CN); Yuanyu Liang, Shenzhen (CN); Deshen Wen, Shenzhen (CN)

(21) Appl. No.: 19/458,996

(22) Filed: Jan. 26, 2026

(30) Foreign Application Priority Data
Apr. 22, 2025 (CN) 202520766488.2
Oct. 28, 2025 (WO) PCT/CN2025/130479

(51) Int. Cl. B60N 3/00

(52) U.S. Cl. CPC B60N 3/005

(57) ABSTRACT

A steering wheel desk includes a first support plate, a second support plate, and a connection assembly. The connection assembly is configured to enable the first support plate and the second support plate to be detachably connected with each other, such that the steering wheel desk has a storage state and a use state. When the steering wheel desk is in the storage state, the first support plate and the second support plate are separated from each other. When the steering wheel desk is in the use state, the first support plate and the second support plate are spliced with each other relative to each other in a length direction of the steering wheel desk to form a desktop, and the first support plate and the second support plate cooperatively form a mounting hole. The mounting hole is configured to be cooperated with a steering wheel.

### CROSS REFERENCE TO RELATED APPLICATIONS

This application claims priorities of: the international patent application No. PCT/CN2025/130479, filed on Oct. 28, 2025; and the Chinese patent application No. 202520766488.2, filed on Apr. 22, 2025, the disclosure of which is incorporated by reference herein in their entireties.

### FIELD OF THE DISCLOSURE

The present disclosure relates to the field of automotive accessories, and in particular, to a steering wheel desk.

### BACKGROUND

A steering wheel desk may be used to be assembled to a steering wheel of a car and can serve as a dining table or a desk, offering convenience in use.

Existing steering wheel desks may be typically of a one-piece design, which occupies a large area when stored. The steering wheel desks need to be placed in a car trunk, back seat, etc., making retrieval and storage inconvenient each time and affecting a riding experience of rear seat passengers. Therefore, existing steering wheel desks have problems of inconvenient storage and use.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a steering wheel desk is provided. The steering wheel desk includes a first support plate, a second support plate, and a connection assembly. The connection assembly is configured to enable the first support plate and the second support plate to be detachably connected with each other, such that the steering wheel desk has a storage state and a use state. When the steering wheel desk is in the storage state, the first support plate and the second support plate are separated from each other. When the steering wheel desk is in the use state, the first support plate and the second support plate are spliced with each other relative to each other in a length direction of the steering wheel desk to form a desktop, and the first support plate and the second support plate cooperatively form a mounting hole. The mounting hole is configured to be cooperated with a steering wheel.

### BRIEF DESCRIPTION OF THE DRAWINGS

Illustrative embodiments of the present disclosure are described in detail below with reference to the attached drawing figures.

FIG. 1 is a structural view of a steering wheel desk according to Embodiment I of the present disclosure.

FIG. 2 is a first exploded view of the steering wheel desk according to Embodiment I of the present disclosure.

FIG. 3 is a second exploded view of the steering wheel desk according to Embodiment I of the present disclosure.

FIG. 4 is a structural view of a first connecting member and a second connecting member according to Embodiment I of the present disclosure.

FIG. 5 is a first exploded view of the steering wheel desk according to Embodiment II of the present disclosure.

FIG. 6 is a second exploded view of the steering wheel desk according to Embodiment II of the present disclosure.

FIG. 7 is a first exploded view of the steering wheel desk according to Embodiment III of the present disclosure.

FIG. 8 is a second exploded view of the steering wheel desk according to Embodiment III of the present disclosure.

FIG. 9 is a structural view of the first connecting member and the second connecting member according to Embodiment III of the present disclosure.

FIG. 10 is a cross-sectional view of a mounting groove and an access channel on a Y-Z plane according to Embodiment III of the present disclosure.

FIG. 11 is a first exploded view of the steering wheel desk according to Embodiment IV of the present disclosure.

FIG. 12 is a second exploded view of the steering wheel desk according to Embodiment IV of the present disclosure.

FIG. 13 is an exploded view among a first seat, a first rotating member, a second seat, and a second rotating member according to Embodiment IV of the present disclosure.

FIG. 14 is a structural view of the second seat and the second rotating member according to Embodiment IV of the present disclosure.

FIG. 15 is a structural view of the first connecting member and the second connecting member according to Embodiment IV of the present disclosure, with the first connecting member and the second connecting member connected with each other FIG. 16 is a structural view of the steering wheel desk according to Embodiment V of the present disclosure.

FIG. 17 is a first exploded view of the steering wheel desk according to Embodiment V of the present disclosure.

FIG. 18 is a second exploded view of the steering wheel desk according to Embodiment V of the present disclosure.

FIG. 19 is a structural view of the steering wheel desk in a use state according to Embodiment VI of the present disclosure.

FIG. 20 is a structural view of the steering wheel desk in a storage state according to Embodiment VI of the present disclosure.

FIG. 21 is a structural view of the steering wheel desk according to Embodiment VII of the present disclosure.

FIG. 22 is a structural view of the steering wheel desk according to Embodiment VIII of the present disclosure, showing a connection plate, a fifth connecting member, and a sixth connecting member.

### NUMERAL REFERENCE IN THE DRAWINGS

1—first support plate; 13—first side storage recess; 131—first card storage recess; 132—first phone storage recess;
2—second support plate; 23—second side storage recess; 231—first card storage recess; 232—first phone storage recess;
120—mounting hole;
3—connection assembly; 31—first connecting member; 32—second connecting member; 33—engagement member; 34—connection shaft; 35—third connecting member; 36—fourth connecting member; 37—connection plate; 38—fifth connecting member; 39—sixth connecting member; 311—first connection portion; 321—second connection portion;
312a—sliding platform; 322a—sliding recess; 3121a—extension portion; 3122a—first stopping platform; 3221a—second stopping platform; 32201a—sliding opening; 32202a—first opening; 361a—snap groove; 371a—snap protrusion;
312b—insertion platform; 322b—insertion slot; 362b—first magnetic attraction member; 372b—second magnetic attraction member; 3121b—elastic protrusion;
312c—mounting platform; 322c—mounting groove; 3121c—protruding portion; 3122c—first stopping portion; 3123c—second stopping portion; 3221c—third stopping portion; 3222c—fourth stopping portion; 32201c—access channel; 32203c—access opening; 32204c—second opening;
312d—positioning platform; 322d—positioning slot; 363d—first seat; 364d—first rotating member; 373d—second seat; 374d—second rotating member; 3631d—first rotating groove; 3731d—second rotating groove; 3000d—driving block; 3001d—guiding groove;
312e—stabilizing groove; 322e—stabilizing platform; 313e—first engagement portion; 3131e—first engagement groove; 323e—second engagement portion; 3231e—second engagement groove; 3111—first engagement face; 3112—first side face; 3211—second engagement face; 3212—second side face; 331—engagement body; 332—first engagement platform; 333—second engagement platform;
4—friction—increasing member;
X—length direction; Y—width direction; Z—thickness direction.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

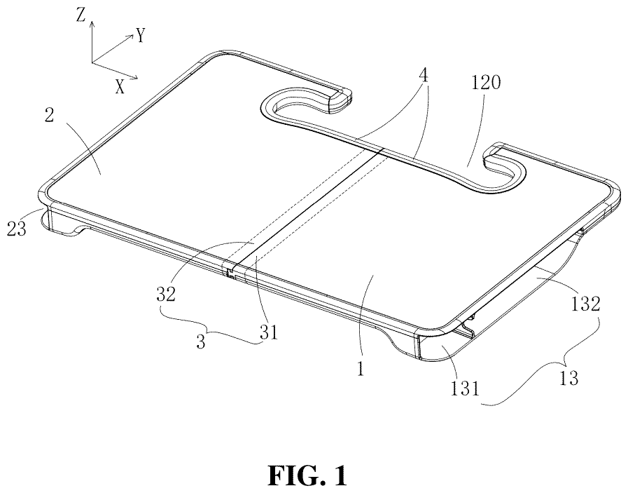

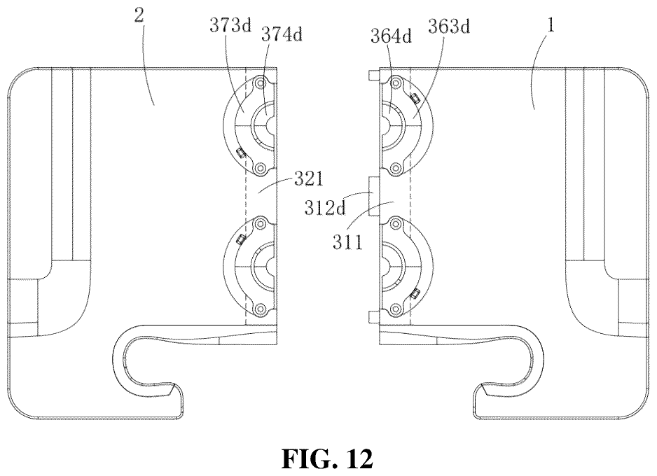

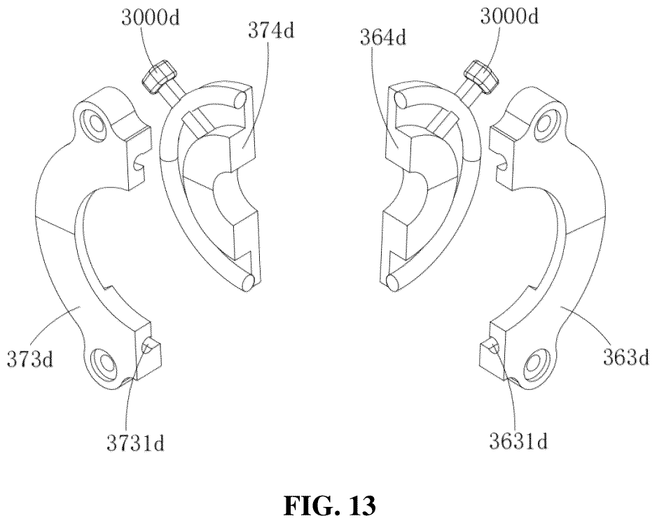

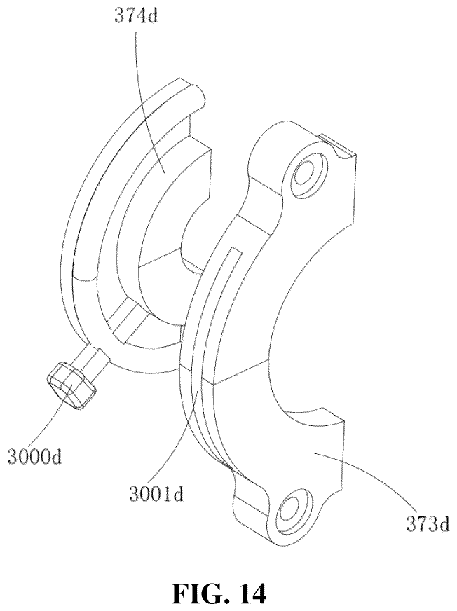

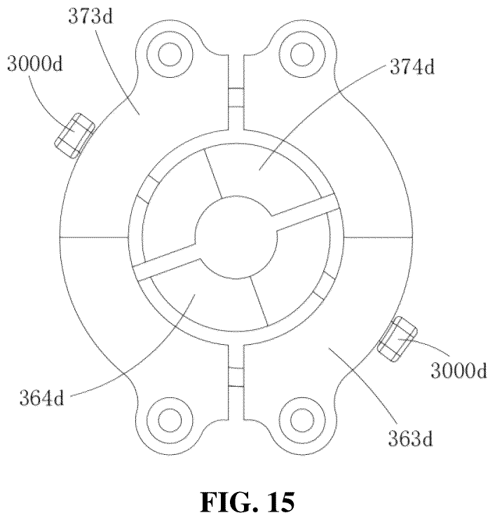

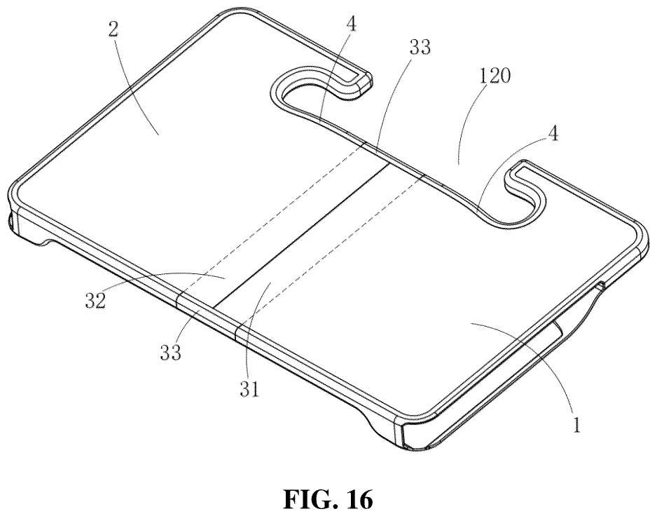

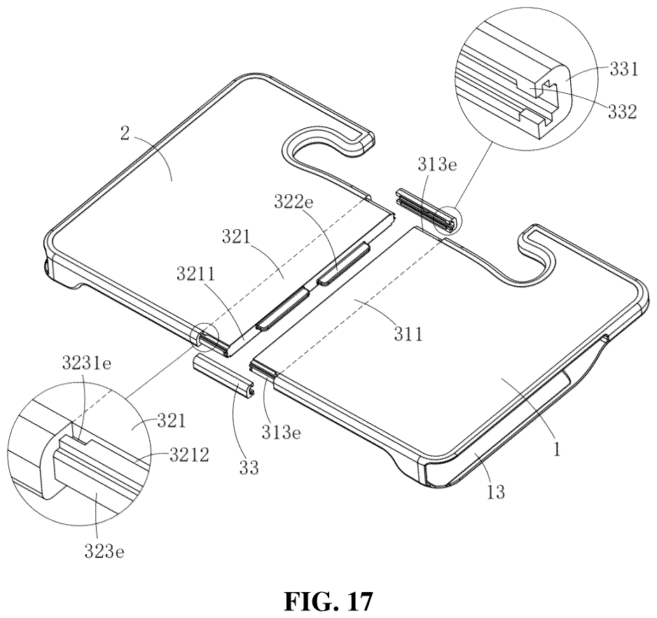

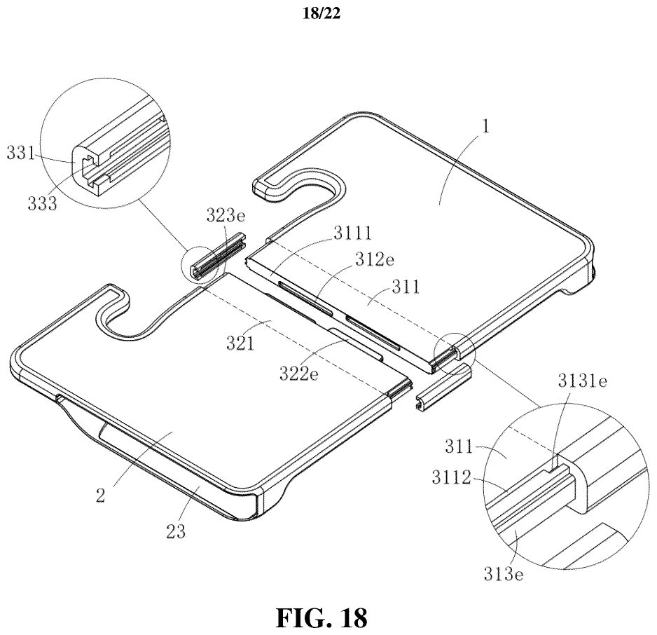

Referring to FIGS. 1 to 22, the present disclosure provides a steering wheel desk. The steering wheel desk may include a first support plate 1, a second support plate 2, and a connection assembly 3. The connection assembly 3 may enable the first support plate 1 and the second support plate 2 to be detachably or foldably connected with each other, so that the steering wheel desk may have a storage state and a use state.

As shown in FIG. 1, when the steering wheel desk is in the use state, the first support plate 1 and the second support plate 2 may be spliced with each other or unfolded relative to each other in a length direction X of the steering wheel desk to form a desktop, and may cooperatively form a mounting hole 120. The mounting hole 120 may cooperate with a steering wheel. When the steering wheel desk is in a storage state, the first support plate 1 and the second support plate 2 may be separated from each other or folded relative to each other, shortening a length of the steering wheel desk, reducing a length requirement for a storage space, to facilitate storage of the steering wheel desk.

Regarding a usage of the steering wheel desk, for ease of description, taking a person in a driver's seat as a reference, the steering wheel may be located in front of the person. In this case, the length direction X of the steering wheel desk may be a width direction of a vehicle body. The first support plate 1 and the second support plate 2 may be assembled with each other in the length direction X of the steering wheel desk, so as to cooperatively form the mounting hole 120. The mounting hole 120 may be located on a side of the steering wheel desk away from the person, i.e., the mounting hole 120 may be located on a side of the steering wheel desk close to the steering wheel. The existing steering wheel may be mounted to the vehicle body with a surface at a slight incline. After the steering wheel desk is placed on the steering wheel through the mounting hole 120, a center of gravity of the steering wheel desk may be located between the steering wheel and the person. The steering wheel desk may exert an obliquely downward pressure on the steering wheel, and the steering wheel may press against a hole wall defining the mounting hole 120 and may exert an obliquely upward reaction force on the steering wheel desk, causing the steering wheel desk to reach a balanced state, thereby achieving fixation of the steering wheel desk.

During use, first, the first support plate 1 and the second support plate 2 may be connected with each other via the connection assembly 3 to place the steering wheel desk in the use state. Then, the steering wheel desk may be placed on the steering wheel from bottom to top or from top to bottom at an angle where a desktop of the steering wheel desk is approximately perpendicular to a steering wheel plane of the steering wheel. After releasing the hand, the steering wheel desk may automatically achieve a relative stability with the steering wheel under gravity. During disassembly, the first support plate 1 and the second support plate 2 may be slightly lift to release a relatively stable state with the steering wheel, then the entire steering wheel desk may be removed and transitioned to the storage state. Therefore, an arrangement of the mounting hole 120 may make mounting and disassembly process of the steering wheel desk very simple and quick, without requiring additional fixing devices.

From the above, it can be seen that the steering wheel desk of this embodiment may be of a segmented structure, allowing a length of the steering wheel desk to be reduced when storage is needed, lowering the space requirement for the storage of the steering wheel desk, and enabling a possibility of storage in a gap between a driver's seat of the vehicle and a center console, thereby improving convenience of use and storage of the steering wheel desk. Specifically, taking a steering wheel desk with dimensions of 42*28 cm as an example, the steering wheel desk may be divided into two parts, the first support plate 1 and the second support plate 2, by splitting the steering wheel desk in half left and right. That is, approximately, dimensions of the first support plate 1 may be 21*28 cm, and dimensions of the second support plate 2 may be 21*28 cm. The first support plate 1 and the second support plate 2 may be inserted in the gap between the driver's seat and the center console or between a passenger's seat and the center console. After insertion, a height (21 cm in this example) of the steering wheel desk may not protrude above a seat height, thus not affecting other operations of the driver. When the steering wheel desk needs to be used, it may not be necessary to leave the seat, and the steering wheel desk may be taken out directly from a side of the driver's or passenger's seat, making operation convenient.

A connection structure of the connection assembly 3 for the first support plate 1 and the second support plate 2 may be a detachable connection structure. In some embodiments, the connection assembly 3 may include a first connecting member 31 and a second connecting member 32. The first connecting member 31 may be arranged on one of the first support plate 1 and the second support plate 2, and the second connecting member 32 may be arranged on the other of the first support plate 1 and the second support plate 2. The first connecting member 31 and the second connecting member 32 may be detachably connected with each other. When the first connecting member 31 and the second connecting member 32 are connected with each other, i.e., the first support plate 1 and the second support plate 2 may be connected with each other in the length direction X of the steering wheel desk to form a desk, the steering wheel desk may be in the use state. When the first connecting member 31 and the second connecting member 32 are separated from each other, the steering wheel desk may be in the storage state, causing the first support plate 1 and the second support plate 2 to be separated from each other for individual storage.

Furthermore, the connection assembly 3 may also be arranged with a locking structure to restrict a movement of the first support plate 11 and a movement of the second support plate 12 after assembly, effectively preventing accidental separation of the first support plate 11 and the second support plate 12 from each other.

The following description takes some embodiments where the first connecting member 31 is arranged on the first support plate 1 and the second connecting member 32 is arranged on the second support plate 2 as examples.

### Embodiment I

As shown in FIGS. 1 to 4, the first connecting member 31 may include a first connection portion 311 and a sliding platform 312a connected to the first connection portion 311. The first connection portion 311 may be connected to the first support plate 1. The first connection portion 311 and the first support plate 1 may be formed as a one single piece or two separate pieces, and the first connection portion 311 may be not limited to the shape or boundary shown in the figures. The second connecting member 32 may include a second connection portion 321, and the second connection portion 321 may define a sliding recess 322a. The second connection portion 321 may be connected to the second support plate 2. The second connection portion 321 and the second support plate 2 may be formed as a one single piece or two separate pieces, and the second connection portion 321 may be not limited to the shape or boundary shown in the figures. The sliding recess 322a may extend along a width direction Y of the steering wheel desk. The sliding platform 312a may enter the sliding recess 322a by sliding along the length direction of the sliding recess 322a. When the sliding platform 312a enters the sliding recess 322a, the first connecting member 31 and the second connecting member 32 may be connected to each other, causing the first support plate 1 and the second support plate 2 to form a complete desktop and enable the steering wheel desk to be in the use state. Conversely, when the sliding platform 312a disengages from the sliding recess 322a, the first connecting member 31 and the second connecting member 32 may be separated from each other to place the steering wheel desk in the storage state.

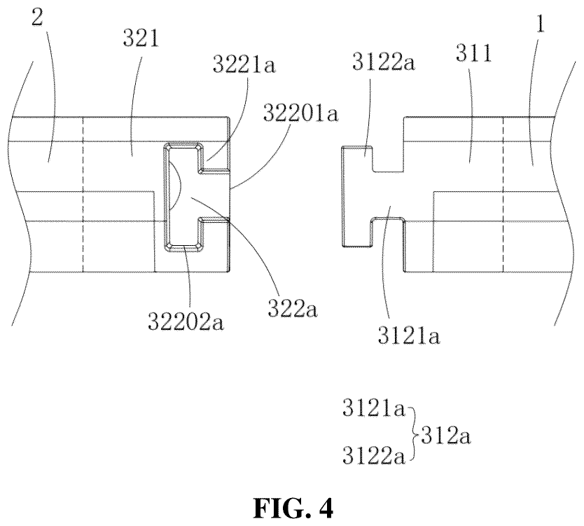

Regarding a structure of the sliding platform 312a, referring to FIG. 4, the sliding platform 312a may include an extension portion 3121a and a first stopping platform 3122a connected to the extension portion 3121a. The first stopping platform 3122a and the extension portion 3121a may be arranged perpendicular to each other, so that a cross-sectional shape of the sliding platform 312a on a X-Z plane may be a T-shape or a L-shape. Alternatively, the first stopping platform 3122a may be spherical, or the first stopping platform 3122a and the extension portion 3121a may be cooperatively arranged in a triangular shape, etc. The second connecting member 32 may include a second stopping platform 3221a formed at the sliding recess 322a. An end of the sliding recess 322a away from the mounting hole 120 may be arranged with a sliding opening 32201a. A side of the sliding recess 322a facing the first connection portion 311 may be further formed with a first opening 32202a. The second stopping platform 3221a may be arranged at the first opening 32202a. The first stopping platform 3122a may enter the sliding recess 322a by sliding from the sliding opening 32201a along the width direction Y of the steering wheel desk, so that the extension portion 3121a may pass through the first opening 32202a. At this time, the first stopping platform 3122a may abut against the second stopping platform 3221a to restrict the first stopping platform 3122a from disengaging from the sliding recess 322a in the length direction X of the steering wheel desk.

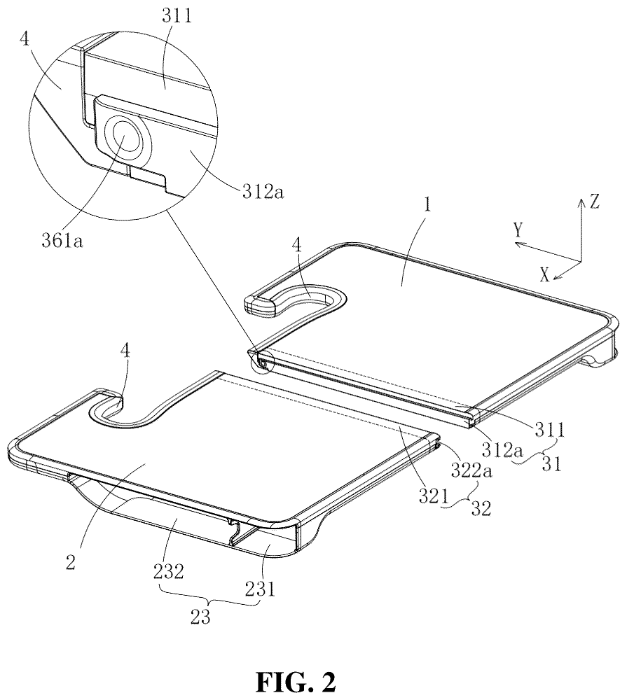

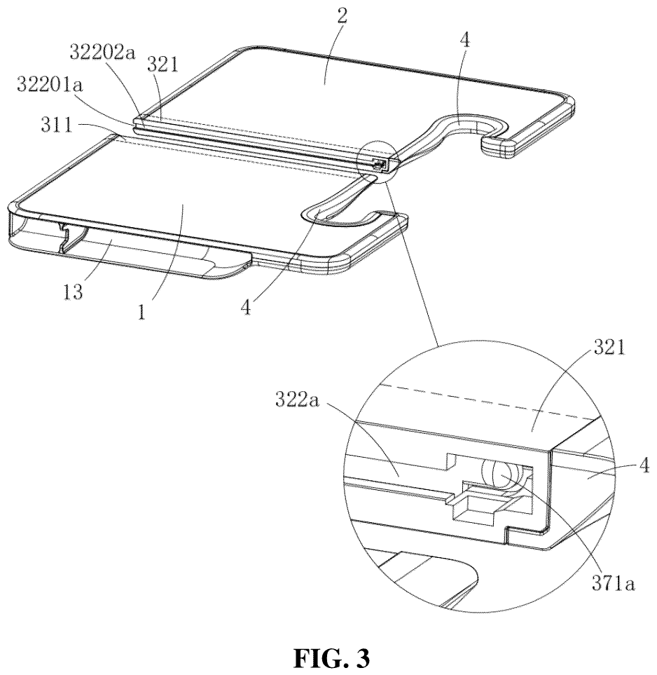

In Embodiment I, when the first support plate 1 and the second support plate 2 are connected with each other, a relative position of the first support plate 1 and the second support plate 2 may be locked by an elastic snap structure to prevent accidental separation of the first support plate 1 and the second support plate 2. Specifically, as shown in FIGS. 2 and 3, a snap groove 361a may be formed on the sliding platform 312a, and a snap protrusion 371a may be arranged in the sliding recess 322a. The snap groove 361a may slide with the sliding platform 312a in the sliding recess 322a, and may finally enable the snap protrusion 371a to be elastically snapped in the snap groove 361a.

Referring to FIG. 3, an end of the sliding recess 322a near the mounting hole 120 forms a snap cavity. The snap protrusion 371a may be arranged in the snap cavity. A side of the snap protrusion 371a facing the snap groove 361a may be arranged with an arc-shaped protrusion. When the sliding platform 312a slides to a position where the snap groove 361a is in the snap cavity, the snap protrusion 371a may be compressed under a guidance of the arc-shaped protrusion, and may elastically reset when the snap groove 361a directly faces the snap protrusion 371a, realizing a snap-fitted engagement of the snap protrusion 371a and the snap groove 361a, thereby restricting a relative movement of the first support plate 1 and the second support plate 2.

When the first support plate 1 and the second support plate 2 are aligned with each other, the snap protrusion 371a may be arranged in the snap groove 361a, achieving limitation of the relative movement of the first support plate 1 and the second support plate 2. The arc-shaped protrusion arranged on the snap protrusion 371a may also be replaced with a spherical protrusion or an inclined protrusion. When the first connecting member 31 is subjected to an external force, the snap protrusion 371a may be caused to elastically deform and leave the snap groove 361a, releasing the restriction on the relative movement of the first support plate 1 and the second support plate 2.

The arrangement where the snap protrusion 371a is arranged in the snap cavity of the sliding recess 322a, compared to an arrangement where the snap protrusion 371a is arranged at the sliding opening 32201a, means that during insertion of the sliding platform 312a in the sliding recess 322a, the snap protrusion 371a may remain largely out of contact with the sliding platform 312a. Only when the sliding platform 312a reaches the snap groove 361a may the sliding platform 312a press against the snap protrusion 371a to cause a deformation of the snap protrusion 371a, thereby effectively reducing a deformation time of the snap protrusion 371a during the assembly process and improving a service life of the snap protrusion 371a.

### Embodiment II

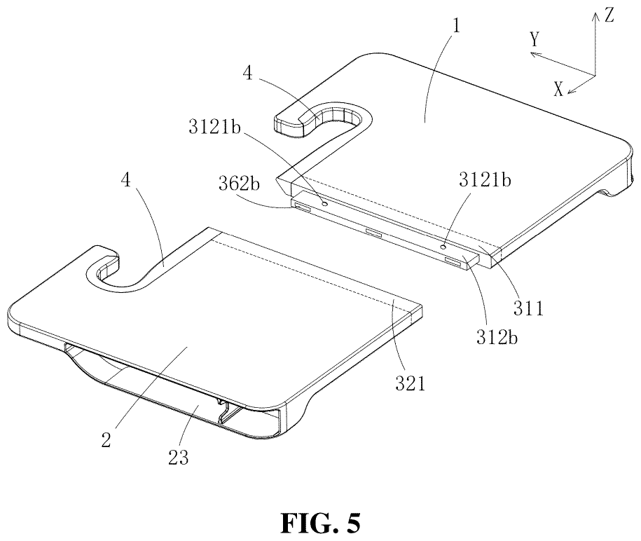

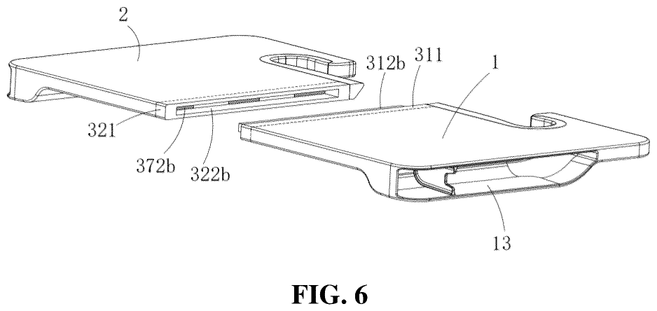

Referring to FIGS. 5 and 6, the first connecting member 31 may include a first connection portion 311 and an insertion platform 312b connected to the first connection portion 311. The first connection portion 311 may be connected to the first support plate 1. The first connection portion 311 and the first support plate 1 may be formed as a one single piece or two separate pieces, and the first connection portion 311 may be not limited to the shape or boundary shown in the figures. The second connecting member 32 may include a second connection portion 321, and the second connection portion 321 may define an insertion slot 322b. The second connection portion 321 may be connected to the second support plate 2. The second connection portion 321 and the second support plate 2 may be formed as a one single piece or two separate pieces, and the second connection portion 321 may be not limited to the shape or boundary shown in the figures. The insertion platform 312b may be inserted in the insertion slot 322b along the length direction X of the steering wheel desk. When the insertion platform 312b is inserted in the insertion slot 322b, the first connecting member 31 and the second connecting member 32 may be connected to each other to place the steering wheel desk in the use state. Conversely, when the insertion platform 312b disengages from the insertion slot 322b, the first connecting member and the second connecting member may be separated from each other to place the steering wheel desk in the storage state.

In Embodiment II, after the first support plate 1 and the second support plate 2 are connected each other, the relative position of the first support plate 1 and the second support plate 2 may be locked via an interference fit between the insertion platform and the insertion slot 322b, or in a magnetic locking manner. Specifically, a first magnetic attraction member 362b may be arranged on the insertion platform 312b, and a second magnetic attraction member 372b may be arranged in the insertion slot 322b. Specifically, the first magnetic attraction member 362b may be arranged on a side face of the insertion platform 312b away from the first connection portion 311. The second magnetic attraction member 372b may be arranged at a bottom portion of the insertion slot 322b. When the insertion platform 312b is inserted in the insertion slot 322b, the first magnetic attraction member 362b and the second magnetic attraction member 372b are arranged face to face. When the insertion platform 312b is inserted in the insertion slot 322b, the first magnetic attraction member 362b and the second magnetic attraction member 372b may be magnetically attracted to each other. Each of the first magnetic attraction member 362b and the second magnetic attraction member 372b may be a magnet, or one of the first magnetic attraction member 362b and the second magnetic attraction member 372b may be a magnet and the other of the first magnetic attraction member 362b and the second magnetic attraction member 372b may be a metal member that may be attracted by the magnet.

Referring to FIGS. 5 and 6, a limiting recess may be formed in a wall of the insertion slot 322b, the insertion platform 312b may further include at least one elastic protrusion 3121b which may engage with the limiting recess. When the insertion platform 312b is inserted in the insertion slot 322b, the elastic protrusion 3121b may be received in the limiting recess to restrict a relative movement between the first support plate 1 and the second support plate 2.

In some embodiments, at least two insertion platforms 312b and at least two insertion slots 322b may be provided. The at least two insertion platforms 312b may be arranged along a width direction of the steering wheel desk. The at least two insertion slots 322b may be arranged along the width direction of the steering wheel desk. When the at least two insertion platforms 312b are inserted into the at least two insertion slots 322, the first support plate 1 and the second support plate 2 are connected to each other.

### Embodiment III

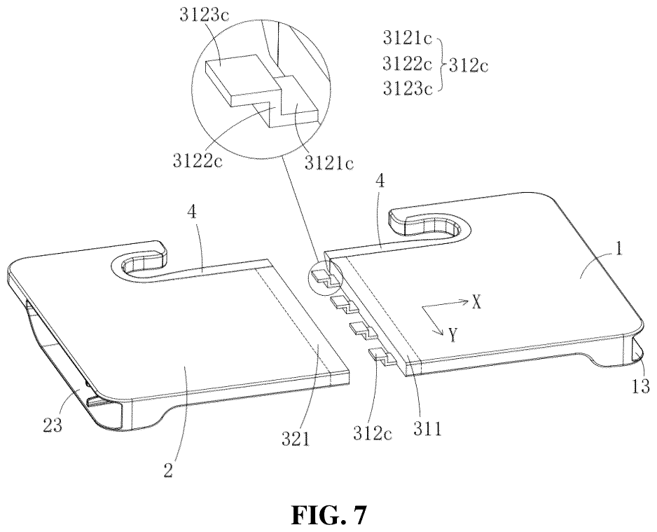

Referring to FIGS. 7 to 10, the first connecting member 31 may include a first connection portion 311 and a mounting platform 312c connected to the first connection portion 311. The first connection portion 311 may be connected to the first support plate 1. The first connection portion 311 and the first support plate 1 may be formed as a one single piece or two separate pieces, and the first connection portion 311 may be not limited to the shape or boundary shown in the figures. The second connecting member 32 may include a second connection portion 321, and the second connection portion 321 may define a mounting groove 322c and an access channel 32201c communicated with the mounting groove 322c. The second connection portion 321 may be connected to the second support plate 2. The second connection portion 321 and the second support plate 2 may be formed as a one single piece or two separate pieces, and the second connection portion 321 may be not limited to the shape or boundary shown in the figures. The access channel 32201c may be formed with an access opening 32203c on a bottom face or a top face of the second connection portion 321. The mounting groove 322c may extend in the width direction Y of the steering wheel desk. A shape of the mounting groove 322c may be matched with a shape of the mounting platform 312c.

The mounting platform 312c may enter the access channel 32201c from the access opening 32203c along a thickness direction Z of the steering wheel desk, and may move into the mounting groove 322c along the width direction Y of the steering wheel desk. When the mounting platform 312c is arranged in the mounting groove 322c, the steering wheel desk may be in the use state. The access channel 32201c may be mainly used to guide the mounting platform 312c to be engaged in the mounting groove 322c.

Specifically, for example, the mounting platform 312c may be arranged in a stepped shape. The mounting platform 312c may include a protruding portion 3121c protruding from the first connection portion 311 towards the second connection portion 321, a first stopping portion 3122c perpendicularly connected to the protruding portion 3121c, and a second stopping portion 3123c perpendicularly connected to the first stopping portion 3122c. Therefore, the protruding portion 3121c, the first stopping portion 3122c, and the second stopping portion 3123c may cooperatively form the mounting platform 312c that may be roughly Z-shaped in the X-Z plane. The second connecting member 32 may further include a third stopping portion 3221c and a fourth stopping portion 3222c. The fourth stopping portion 3222c may serve a bottom wall of the mounting groove 322c. A side of the mounting groove 322c facing the first connection portion 311 may be formed with a second opening 32204c communicated with the access channel 32201c. The third stopping portion 3221c may be arranged at the second opening 32204c. The fourth stopping portion 3222c may be arranged at the access opening 32203c.

In the structure shown in the figures, the access opening 32203c may be formed on a bottom face of the second connection portion 321. When the steering wheel desk needs to be used, the second stopping portion 3123c may be enabled to enter the access channel 32201c from the access opening 32203c from bottom to top along the thickness direction Z of the steering wheel desk. Then, an external force may be applied along the width direction Y of the steering wheel desk to drive the second stopping portion 3123c to slide above the fourth stopping portion 3222c. At this time, the protruding portion 3121c may pass through the second opening 32204c, and an entirety of the mounting platform 312c may be arranged in the mounting groove 322c, finally causing the steering wheel desk to enter the use state. When the steering wheel desk is in the use state, the first stopping portion 3122c may abut against the third stopping portion 3221c to restrict the mounting platform 312c from disengaging from the mounting groove 322c in the length direction X of the steering wheel desk, and the second stopping portion 3123c may abut against the fourth stopping portion 3222c to restrict the mounting platform 312c from disengaging from the mounting groove 322c along the thickness direction Z of the steering wheel desk.

Therefore, when the mounting platform 312c needs to be separated from the mounting groove 322c, it may be necessary to push the mounting platform 312c in the width direction Y of the steering wheel desk, so that the second stopping portion 3123c may disengage from the fourth stopping portion 3222c, and then apply force to the first support plate 1 in the thickness direction Z of the steering wheel desk to disengage the mounting platform 312c from the access channel 32201c.

Furthermore, as shown in FIG. 7, the first connection portion 311 may be arranged with a plurality of mounting platforms 312c in the width direction Y of the steering wheel desk, and the second connection portion 321 may define a plurality of access channels 32201c and a plurality of mounting grooves 322c in the width direction Y of the steering wheel desk. The plurality of mounting platforms 312c may be associated one-to-one with the plurality of access channels 32201c and the plurality of mounting grooves 322c, thereby strengthening connection stability between the first connection portion 311 and the second connection portion 321.

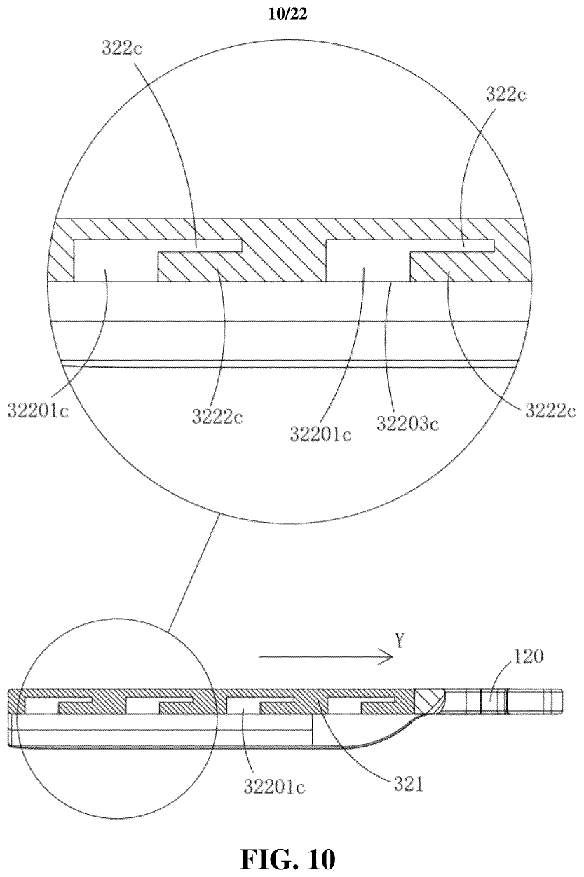

It should be noted that a shape of the access channel 32201c may be not limited, as long as it may allow the mounting platform 312c to enter the access channel 32201c and then move into the mounting groove 322c along an extension path of the access channel 32201c. As shown in FIG. 10, the access channel 32201c and the mounting groove 322c may be distributed in the width direction Y of the steering wheel desk, correspondingly allowing the mounting platform 321c to translate in the Y direction in the access channel 32201c to enter the mounting groove 322c.

It can be seen that the shape of the mounting platform 312c may not be limited to the Z shape described above, but may also be other shapes.

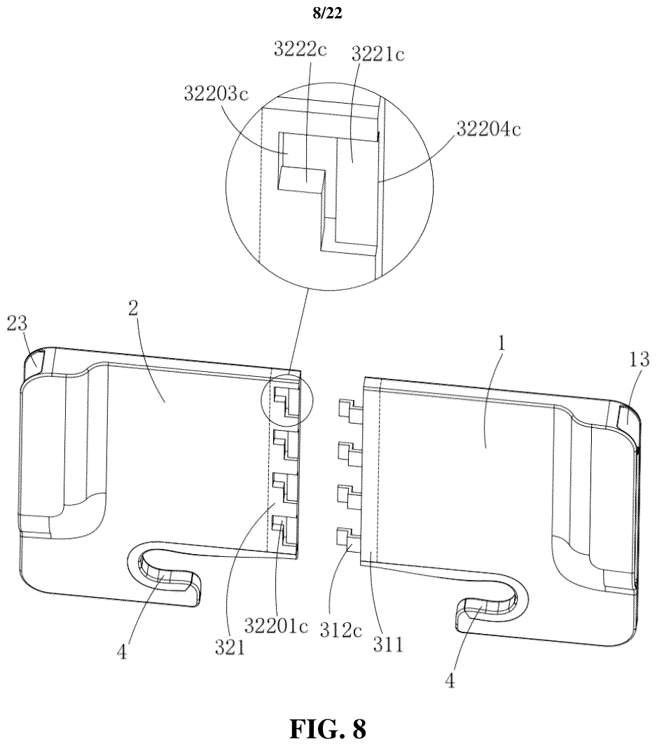

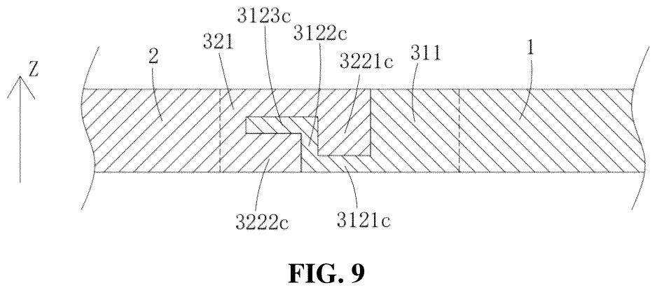

For example, the above Embodiment III is as shown in FIGS. 8 and 9, where the mounting groove 322c may extend to the bottom face of the second connection portion 321. However, in other cases, the mounting platform 312c may be moved upward in the Z direction on the basis of that shown in FIG. 9, or the shape of the mounting platform 312c may be changed, ultimately forming the mounting platform 312c of other shape such as L shape, T shape, etc. The shape of the mounting groove 322c may be arranged correspondingly to the shape of the mounting platform 312c, i.e., the mounting groove 322c may be also moved upward, only needing to ensure that the mounting platform 312c may not disengage from the mounting groove 322c in the X direction and the Z direction. In this case, the protruding portion 3121c may perform the function of the second stopping portion 3123c, i.e., the protruding portion 3121c may abut against the fourth stopping portion 3222c. Specifically, a cross-sectional shape of the mounting groove 322c on a Y-Z plane may be the same as a cross-sectional shape of the mounting platform 321c, achieving a purpose of accommodating the mounting platform 321c.

Specifically, the mounting platform 312c may include an extension segment and a limiting segment. The extension segment may be connected to the first connection portion 311. The limiting segment may be cooperated with a limiting structure of the sliding recess 322a to restrict a movement of the mounting platform 312c in the X direction and the Z direction. For example, in Embodiment III, the extension segment may be the protruding portion 3121c, and the limiting segment may be the first stopping portion 3122c and second stopping portion 3123c. In other embodiments, the limiting segment may be a plate-like member extending in the Z direction, so that an entirety of the mounting platform 312c may be L-shaped or T-shaped in the X-Z cross-section. The limiting segment may also be approximately cylindrical, so that the entirety of the mounting platform 312c may be rail-shaped in the X-Z cross-section. The limiting segment may also be a triangular structure with a cross-sectional size decreasing towards the extension segment, etc., which is not uniquely limited here.

### Embodiment IV

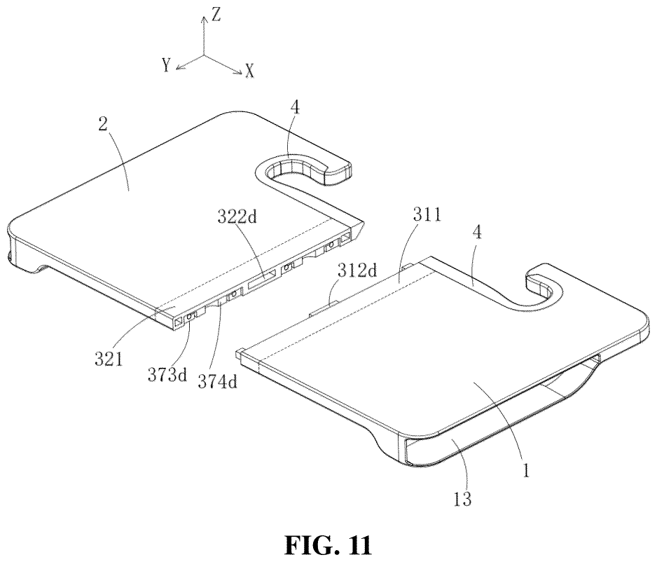

Referring to FIGS. 11 to 15, the first connecting member 31 may include a first connection portion 311, a positioning platform 312d connected to the first connection portion 311, a first seat 363d, and a first rotating member 364d. The first connection portion 311 may be connected to the first support plate 1. The first connection portion 311 and the first support plate 1 may be formed as a one single piece or two separate pieces, and the first connection portion 311 may be not limited to the shape or boundary shown in the figures. The first seat 363d may be fixedly connected to a bottom face of the first connection portion 311 by screws. The first seat 363d may define a first rotating groove 3631d which may be semi-arc-shaped. The first rotating member 364d may perform arc sliding along the first rotating groove 3631d. The second connecting member 32 may include a second connection portion 321, a second seat 373d, and a second rotating member 374d. The second connection portion 321a may define a positioning slot 322d. The second connection portion 321 may be connected to the second support plate 2. The second connection portion 321 and the second support plate 2 may be formed as a one single piece or two separate pieces, and the second connection portion 321 may be not limited to the shape or boundary shown in the figures. The second seat 373d may be fixedly connected to a bottom face of the second connection portion 321 by screws. The second seat 373d may define a second rotating groove 3731d which may be semi-arc-shaped. The second rotating member 374d may perform arc sliding along the second rotating groove 3731d.

When the steering wheel desk needs to be used, the positioning platform 312d may be inserted in the positioning slot 322d along the length direction X of the steering wheel desk, so that the first rotating groove 3631d on the first seat 363d and the second rotating groove 3731d on the second seat 373d may cooperatively form a concentric, same-radius, and annular groove. Sliding the first rotating member 364d may enable a part of the first rotating member 364d to enter the second rotating groove 3731d, and sliding the second rotating member 374d may enable a part of the second rotating member 374d to enter the first rotating groove 3631d. Moreover, when the first rotating member 364d partially enters the second rotating groove 3731d, and the second rotating member 374d partially enters the first rotating groove 3631d, the steering wheel desk may be in the use state. At the same time, the first connecting member 31 and the second connecting member 32 may be relatively fixed to each other in the length direction X, width direction Y, and thickness direction Z of the steering wheel desk. The first seat 363d, the first rotating member 364d, the second seat 373d, and the second rotating member 374d may be locking structures in Embodiment IV.

Moreover, to facilitate the user in driving a movement of the first rotating member 364d and the second rotating member 374d, each of the first seat 363d and the second seat 373d may define a guiding groove 3001d. The guiding groove 3001d of the first seat 363d may communicate the first rotating groove 3631d with the outside, and the guiding groove 3001d of the second seat 373d may communicate the second rotating groove 3731d with the outside. Simultaneously, each of the first rotating member 364d and the second rotating member 374d may be arranged with a driving block 3000d. The driving block 3000d of each of the first rotating member 364d and the second rotating member 374d may extend out of the guiding groove 3001d of a respective one of the first seat 363d and the second seat 373d. The user may push the driving block 3000d to cause the first rotating member 364d or the second rotating member 374d to move.

For this Embodiment IV, the positioning platform 312d and the positioning slot 322d may only serve positioning and guiding functions. A connection and fixation of the first support plate 1 and the second support plate 2 may be achieved solely relying on the first seat 363d, the first rotating member 364d, the second seat 373d, and the second rotating member 374d. That is, in some other embodiments, the positioning platform 312d and the positioning slot 322d may be omitted.

### Embodiment V

Referring to FIGS. 16 to 18, the first connecting member 31 may include a first connection portion 311. The first connection portion 311 may define a stabilizing groove 312e and may be arranged with a first engagement portion 313e. The first connection portion 311 may be connected to the first support plate 1. The first connection portion 311 and the first support plate 1 may be formed as a one single piece or two separate pieces, and this first connection portion 311 may be not limited to the shape or boundary shown in the figures. The first connection portion 311 may have a first engagement face 3111 and a first side face 3112 adjacent to the first engagement face 3111. The stabilizing groove 312e may be formed on the first engagement face 3111. The first engagement portion 313e may be formed on the first side face 3112. An extension direction of a length of the stabilizing groove 312e may be perpendicular to an extension direction of a length of the first engagement portion 313e. A first engagement groove 3131e may be formed on the first engagement portion 313e. The second connecting member 32 may include a second connection portion 321, a stabilizing platform 322e formed on the second connection portion 321, and a second engagement portion 323e formed on the second connection portion 321. The second connection portion 321 may be formed on the second support plate 2. The second connection portion 321 and the second support plate 2 may be formed as a one single piece or two separate pieces, and this second connection portion 321 may be not limited to the shape or boundary shown in the figures. The second connection portion 321 may have a second engagement face 3211 opposite to the first engagement face 3111 and a second side face 3212 adjacent to the second engagement face 3211. The stabilizing platform 322e may be formed on the second engagement face 3212. The second engagement portion 323e may be formed on the second side face 3212. An extension direction of the second engagement portion 323e may be the same as an extension direction of the first engagement portion 313e. The second engagement portion 323e may define a second engagement groove 3231e.

Each of the first engagement face 3111 and the second engagement face 3211 may be parallel to the Y-Z plane, while each of the first side face 3112 and the second side face 3212 may be parallel to the X-Z plane. For example, the first side face 3112 may be located on a side of the first support plate 1 facing the user, and the second side face 3212 may be located on a side of the second support plate 2 facing the user.

In this embodiment, the connection assembly 3 may further include at least one engagement member 33. The engagement member 33 may include a engagement body 331, a first engagement platform 332, and a second engagement platform 333. Each of the first engagement platform 332 and the second engagement platform 333 may be formed on the engagement body 331. The engagement body 331 may have a certain capacity for elastic deformation.

The first connecting member 31 and the second connecting member 32 may be spliced with each other in the length direction X of the steering wheel desk, i.e., the stabilizing platform 322e may be inserted in the stabilizing groove 312e along the length direction X of the steering wheel desk, and the first engagement face 3111 may abut against the second engagement face 3211. At this time, the first engagement groove 3131e and the second engagement groove 323 le may be spaced apart from each other, i.e., the first engagement groove 3131e and the second engagement groove 3231e may not be directly communicated with each other. The engagement body 331 may then cover the first engagement portion 313e and the second engagement portion 323e, causing the first engagement platform 332 to be elastically engaged in the first engagement groove 3131e, and the second engagement platform 333 to be elastically engaged in the second engagement groove 3231e. When the steering wheel desk needs to be stored, the user may apply an external force to the engagement member 33. The engagement body 331 may elastically deform, causing the first engagement platform 332 to disengage from the first engagement groove 3131e, and the second engagement platform 333 to disengage from the second engagement groove 3231e. Finally, after removing the engagement member 33, the user may pull the first support plate 1 and the second support plate 2 apart from each other in the length direction X of the steering wheel desk.

### Embodiment VI

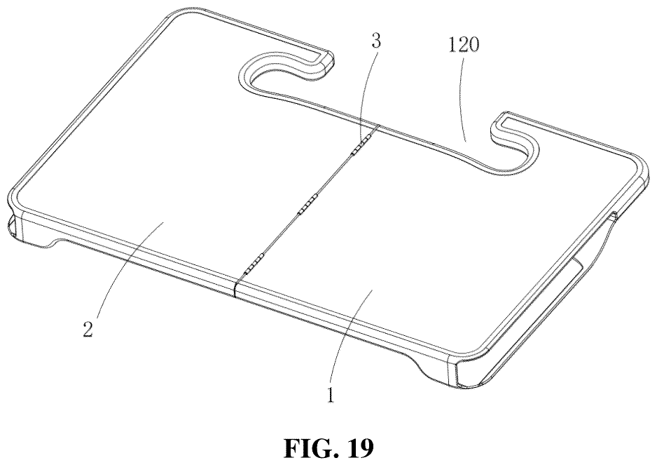

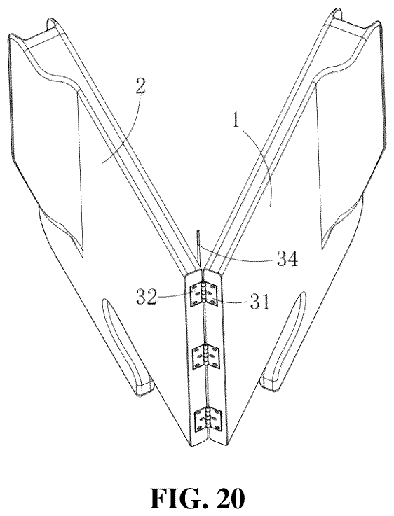

Referring to FIGS. 19 and 20, each of the first connecting member 31 and the second connecting member 32 may be a plate-like structure. The first connecting member 31 may be tightened on the first support plate 1 by bolts, and the second connecting member 32 may be tightened on the second support plate 2 by bolts. The first connecting member 31 and the second connecting member 32 may be detachably connected with each other by a connection shaft 34. The connection shaft 34 may pass through the first connecting member 31 and the second connecting member 32, so that both the first connecting member 31 and the second connecting member 32 may rotate about the connection shaft 34. In this case, the first connecting member 31, the second connecting member 32, and the connection shaft 34 may cooperatively form a structure similar to a hinge. A difference between this structure and a hinge structure may be that the connection shaft 34 in this structure may be pulled out. Each of an end of the first connecting member 31 and an end of the second connecting member 32 adjacent to the end of the first connecting member 31 may be of a tubular structure, and the connection shaft 34 may simultaneously pass through the tubular structure of the first connecting member 31 and the tubular structure of the second connecting member 32.

When the connection shaft 34 passes through the first connecting member 31 and the second connecting member 32, and the first support plate 1 and the second support plate 2 are unfolded in the length direction X of the steering wheel desk, the steering wheel desk may be in the use state; when the connection shaft 34 disengages from the first connecting member 31 and the second connecting member 32, the first support plate 1 and the second support plate 2 may be stored separately, and the steering wheel desk may be in the storage state.

Furthermore, when the connection shaft 34 passes through the first connecting member 31 and the second connecting member 32, the connection shaft 34 may be located above a working face of the first support plate 1. In this case, when the steering wheel desk is in the use state and assembled to the steering wheel, the first support plate 1 and the second support plate 2 will not naturally separate from each other.

### Embodiment VII

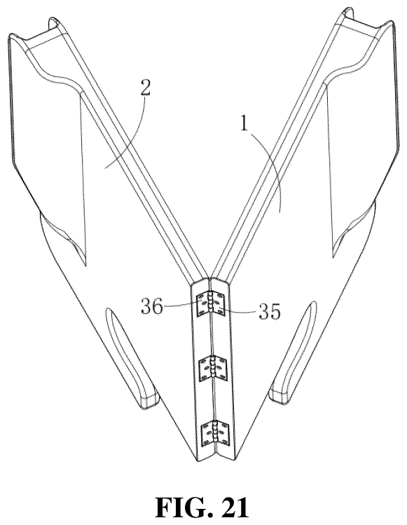

Regarding the structure of the connection assembly 3 for the first support plate 1 and the second support plate 2, it can also be a foldable connection structure. Referring to FIG. 21, the connection assembly 3 may include a third connecting member 35 and a fourth connecting member 36. The third connecting member 35 may be mounted to the first support plate 1, and the fourth connecting member 36 may be mounted to the second support plate 2. The third connecting member 35 and the fourth connecting member 36 may be hingedly connected to each other. The third connecting member 35 and the fourth connecting member 36 may cooperatively form a hinge structure, the third connecting member 35 may be tightened to the first support plate 1 by screws, and the fourth connecting member 36 may be tightened to the second support plate 2 by screws. That is, in Embodiment VII, the third connecting member 35 and the fourth connecting member 36 may be always connected to each other, but may rotate relative to each other. When the hinge structure formed by the third connecting member 35 and the fourth connecting member 36 is closed, the first support plate 2 and the second support plate 2 may be arranged horizontally and flush with each other, and the steering wheel desk may be in the unfolded use state; when the hinge structure formed by the third connecting member 35 and the fourth connecting member 36 is opened, the first support plate 1 and the second support plate 2 may be in a mutually folded state, correspondingly the steering wheel desk may be in the storage state, the steering wheel desk may be folded in half at a hinge shaft of the third connecting member 35 and the fourth connecting member 36, also achieving the purpose of reducing the storage length.

### Embodiment VIII

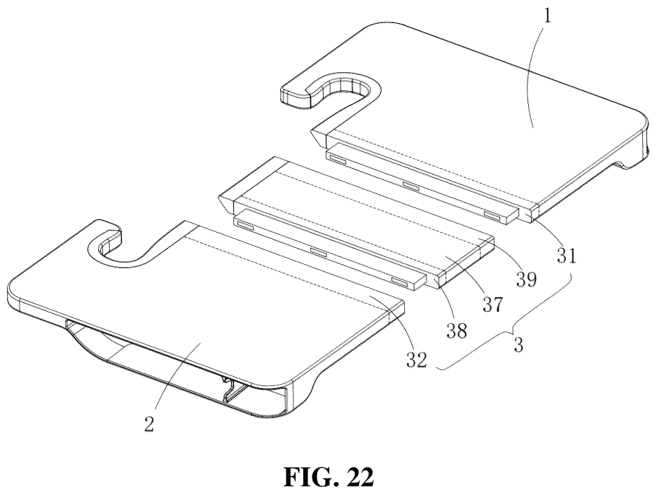

Regarding the structure of the connection assembly 3, referring to FIG. 22, the connection assembly 3 may include a first connecting member 31, a second connecting member 32, a connection plate 37, a fifth connecting member 38, and a sixth connecting member 39. Each of the first connecting member 31 and the second connecting member 32 may be as described in any one of the above-mentioned embodiments. The connection plate 37 may be arranged between the first support plate 1 and the second support plate 2. Each of the fifth connecting member 38 and the sixth connecting member 39 may be connected to the connection plate 37. The first connecting member 31 and the second connecting member 32 may be detachably connected to each other. Or the first connecting member 31 and the sixth connecting member 39 may be detachably connected to each other, and the second connecting member 32 and the fifth connecting member 38 may be detachably connected to each other. For example, when the steering wheel desk is applied to a small steering wheel, the connection plate 37 may be removed, and the first connecting member 31 and the second connecting member 32 may be connected with each other to form a smaller mounting hole 120. When the steering wheel desk is applied to a larger steering wheel, the first connecting member 31 may be connected to the sixth connecting member 39, and the second connecting member 32 may be connected to the fifth connecting member 38, using the connection plate 37 to widen the length of the steering wheel desk and form a larger mounting hole 120. In this embodiment, the steering wheel desk may be divided into three parts for storage. It can be understood that in other embodiments, when the steering wheel desk needs to be divided to more parts for storage, additional connection plates 37, fifth connecting members 38, and sixth connecting members 39 can be further provided.

Furthermore, in some embodiments, as shown in FIGS. 1 and 2, a first side storage recess 13 may be formed on a side of the first support plate 1 away from the second support plate 2, and a second side storage recess 23 may be formed on a side of the second support plate 2 away from the first support plate 1. After the first support plate 1 and the second support plate 2 are separated from each other, each of the first support plate 1 and the second support plate 2 may be inserted in a gap between the driver's seat and the center console or between the passenger's seat and the center console. When the first support plate 1 and the second support plate 2 are vertically inserted in the gap between the driver's/passenger's seat and the center console, the side of the first support plate 1 with the first side storage recess 13 may face upward, and the side of the second support plate 2 with the second side storage recess 23 may face upward, thereby allowing the user to store items, such as mobile phones, ID cards, bank cards, etc. Specifically, the first side storage recess 13 may include a first card storage recess 131 and a first phone storage recess 132, and the second side storage recess 23 may include a second card storage recess 231 and a second phone storage recess 232. Furthermore, in other embodiments, only the first side storage recess 13 may be formed in the first support plate 1, or only the second side storage recess 23 may be formed in the second support plate 2.

In some embodiments, for ease of storage and use, the first support plate 1 and the second support plate 2 may be mirror-symmetrically arranged relative to each other.

In some embodiments, when the steering wheel desk is mounted to the steering wheel through the mounting hole 120, the first support plate 1 and the second support plate 2 may be arranged horizontally or inclined upward at an angle of 0-5°. Considering usage situations, the steering wheel desk being used horizontally may be an ideal state; when the steering wheel desk is under load, the first support plate 1 and the second support plate 2 may be pressed and tend to move downward. The design of the first support plate 1 and the second support plate 2 being slightly inclined upward may counteract this tendency, causing the steering wheel desk to tend towards the ideal state during use. According to a type of steering wheel, a size and shape of the mounting hole 120 may be adaptively adjusted to control an inclination angle of the first support plate 1 and the second support plate 2.

In some embodiments, referring to FIGS. 1, 5, 7, 11, and 16, the steering wheel desk may further include at least one friction-increasing member 4. The friction-increasing member 4 may be arranged to cover an edge of the first support plate 1 and the second support plate 2 at the mounting hole 120. The friction-increasing member 4 may be made of a material with a high friction coefficient, such as rubber or silicone. The friction-increasing member 4 may serve as a protective layer to provide protection for the steering wheel desk. Moreover, the friction-increasing member 4 may increase a frictional resistance between the steering wheel desk and the steering wheel during use, thereby facilitating fastening between the steering wheel desk and the steering wheel. The number of the at least one friction-increasing member 4 may be two, each friction-increasing member 4 may be mounted to a respective one of the first support plate 1 and the second support plate 2.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

1. A steering wheel desk, comprising:
a first support plate;
a second support plate; and
a connection assembly, configured to enable the first support plate and the second support plate to be detachably connected with each other, such that the steering wheel desk has a storage state and a use state;
when the steering wheel desk is in the storage state, the first support plate and the second support plate are separated from each other; when the steering wheel desk is in the use state, the first support plate and the second support plate are spliced with each other relative to each other in a length direction of the steering wheel desk to form a desktop, and the first support plate and the second support plate cooperatively form a mounting hole; the mounting hole is configured to be cooperated with a steering wheel.

2. The steering wheel desk according to claim 1, wherein the connection assembly comprises a first connecting member and a second connecting member;
the first connecting member comprises a first connection portion and a sliding platform connected to the first connection portion, and the first connection portion is connected to one of the first support plate and the second support plate;
the second connecting member comprises a second connection portion, the second connection portion defines a sliding recess, and the second connection portion is connected to the other of the first support plate and the second support plate.

3. The steering wheel desk according to claim 2, wherein the sliding recess extends along a width direction of the steering wheel desk, the sliding platform is configured to enter the sliding recess by sliding along an extension direction of the sliding recess, and when the sliding platform enters in the sliding recess, the first connecting member and the second connecting member are connected to each other and the steering wheel desk is in the use state; when the sliding platform disengages from the sliding recess, the first connecting member and the second connecting member are separated from each other and the steering wheel desk is in the storage state.

4. The steering wheel desk according to claim 3, wherein the sliding platform comprises an extension portion and a first stopping platform connected to the extension portion, the second connecting member comprises a second stopping platform formed at the sliding recess, the sliding recess is formed with a sliding opening at an end of the sliding recess away from the mounting hole, the sliding recess is formed with a first opening on a side of the sliding recess facing the first connection portion, and the second stopping platform is arranged at the first opening;
the first stopping platform is configured to enter the sliding recess by sliding from the sliding opening along the width direction of the steering wheel desk, such that the extension portion passes through the first opening, and the first stopping platform is configured to abut against the second stopping platform to restrict the first stopping platform from disengaging from the sliding recess in the length direction of the steering wheel desk.

5. The steering wheel desk according to claim 4, wherein the sliding platform defines a snap groove, the second connecting member comprises a snap protrusion arranged in the sliding recess, the snap groove is slidable with the sliding platform in the sliding recess, and the snap protrusion is configured to be elastically snap-fitted in the snap groove; when the snap protrusion is elastically snap-fitted in the snap groove, the steering wheel desk is in the use state.

6. The steering wheel desk according to claim 5, wherein the snap protrusion is arranged at an end of the sliding recess close to the mounting hole.

7. The steering wheel desk according to claim 4, wherein the first stopping platform and the extension portion are arranged perpendicular to each other.

8. The steering wheel desk according to claim 7, wherein a cross-sectional shape of the sliding platform on a X-Z plane is a T-shape; the X-Z plane is cooperatively defined by the length direction of the steering wheel desk the thickness direction of the steering wheel desk.

9. The steering wheel desk according to claim 5, wherein a side of the snap protrusion facing the snap groove is arranged with an arc-shaped protrusion.

10. The steering wheel desk according to claim 1, wherein the first connection portion and the first support plate are formed as a one single piece, and the second connection portion and the second support plate are formed as a one single piece.

11. The steering wheel desk according to claim 1, wherein when the steering wheel desk is mounted to the steering wheel through the mounting hole, the first support plate and the second support plate are arranged inclined upward at an angle of 0-5°.

12. The steering wheel desk according to claim 1, further comprising at least one friction-increasing member, wherein the at least one friction-increasing member is arranged to cover an edge of the first support plate and the second support plate at the mounting hole.

13. The steering wheel desk according to claim 12, wherein the number of the at least one friction-increasing member is two, each of the two friction-increasing members is mounted to a respective one of the first support plate and the second support plate.

14. The steering wheel desk according to claim 1, wherein the first support plate defines a first side storage recess on a side of the first support plate away from the second support plate, and/or the second support plate defines a second side storage recess a side of the second support plate away from the first support plate.

15. The steering wheel desk according to claim 14, wherein each of the first side storage recess and the second side storage recess comprises a card storage recess and a phone storage recess.

16. The steering wheel desk according to claim 1, wherein the connection assembly comprises a first connecting member and a second connecting member;
the first connecting member comprises a first connection portion and at least one insertion platform connected to the first connection portion, and the first connection portion is connected to one of the first support plate and the second support plate;
the second connecting member comprises a second connection portion and an insertion slot formed in the second connection portion, and the second connection portion is connected to the other one of the first support plate and the second support plate;
the at least one insertion platform is configured to be inserted in the insertion slot along the length direction of the steering wheel desk, and when the at least one insertion platform is inserted in the insertion slot, the first connecting member and the second connecting member are connected to each other, and the steering wheel desk is in the use state; when the at least one insertion platform is disengaged from the insertion slot, the first connecting member and the second connecting member are separated from each other, and the steering wheel desk is in the storage state.

17. The steering wheel desk according to claim 16, wherein the first connecting member further comprises a first magnetic attraction member arranged on the insertion platform, the second connecting member further comprises a second magnetic attraction member arranged in the insertion slot, and when the at least one insertion platform is inserted in the insertion slot, the first magnetic attraction member and the second magnetic attraction member are magnetically attracted to each other.

18. The steering wheel desk according to claim 17, wherein the first magnetic attraction member is arranged on a side face of the at least one insertion platform away from the first connection portion.

19. The steering wheel desk according to claim 16, wherein at least one limiting recess is formed in a wall of the insertion slot, the insertion platform further comprises at least one elastic protrusion configured to engage with the limiting recess, and when the at least one insertion platform is inserted in the insertion slot, the elastic protrusion is received in the at least one limiting recess to restrict a relative movement between the first support plate and the second support plate.

20. The steering wheel desk according to claim 19, wherein the number of the at least one insertion platform is at least two, and the at least two insertion platforms are arranged along a width direction of the steering wheel desk.
